(19) United States
(12) Patent Application Publication
(10) Pub. No.: US 2023/0402206 A1
(43) Pub. Date: Dec. 14, 2023

(54) GAS AND FLUID BLOCKED CABLE

(71) Applicant: WireCo WorldGroup Inc., Prairie Village, KS (US)

(72) Inventors: Vadim Protasov, Houston, TX (US); Dustin Dunning, Fulshear, TX (US); Emilio Mondragón, Mexico City (MX); Diego Figueroa, Jilotepec (MX); Ivan Reyes, Santa Martha (MX)

(21) Appl. No.: 18/332,152

(22) Filed: Jun. 9, 2023

Related U.S. Application Data
(60) Provisional application No. 63/350,925, filed on Jun. 10, 2022.

(51) Int. Cl. H01B 7/285; H01B 7/18; H01B 13/32; H01B 13/00; H01B 11/22

(52) U.S. Cl. CPC H01B 7/285; H01B 7/1875; H01B 13/322; H01B 13/0036; H01B 13/0016; H01B 11/22

(57) ABSTRACT

An electromechanical cable that has fluid/gas migration protection is provided as well as a method for manufacturing a fluid/gas migration protected electromechanical cable. The cable can include a core having at least one conductor or fiber optic, a first jacket layer surrounding the core, a sealing layer surrounding the first jacket layer, and a first armor layer surrounding the sealing layer. In one embodiment, the sealing layer can be applied to the cable in a viscous material state and may be a two-part epoxy or synthetic filler material to form a seal between one or more spaces between the armor wire layer and the first jacket layer. In one embodiment, the sealing layer can be applied to the cable in a solid material state and may be a thermoplastic elastomer or silicone-based material or a combination of both.

### CROSS-REFERENCE TO RELATED APPLICATIONS

The present application claims priority to U.S. Provisional Patent Application No. 63/350,925 entitled “Fluid Blocked Jacketed Cable,” filed Jun. 10, 2022, and currently pending. The entire disclosure, including the specification and drawings, of U.S. Provisional Patent Application No. 63/350,925 is incorporated herein by reference.

### FIELD OF THE INVENTION

The present invention relates to electromechanical cables, and in particular an electromechanical cable that prohibits and/or limits fluid/gas migration and has particular utility for providing power to down-hole apparatuses in the extraction of subterranean natural resources.

### BACKGROUND OF THE INVENTION

Electromechanical cables, also called wirelines in drilling operations, are commonly used to provide electricity to down-hole apparatuses in the oil and gas industry as well as numerous other subterranean activities. These types of down-hole or down-well applications have present elevated temperatures and pressures. Such applications may cause fluid and/or gas migration into the cable core, such as from migration through the thermoplastic insulation of the cable. Further, the various pressures, forces, and twisting of the cables and wirelines along the length of the drilling bore (particularly deep within the bore) can cause a jacket of the cable to shift and move. Such shifting may allow gas and/or fluid to migrate into the cable. As a result, the cable core must be sealed.

Current solutions and methods for preventing fluid/gas migration involves embedding the armor wires of the cable into a solid, non-deformable polymer jacket layer that is extruded around the cable core. However, this process is complex, requiring the armor wires and polymer layer to be heated in order to enable the polymer layer to be deformed, and subsequently applying compressive force to embed the armor wires into the polymer. This process is lengthy and creates opportunities for leaks due to inconsistencies along the length of the cable. For example, small gaps or openings may still exist between the armor wires and/or the polymer jacket layer that can allow for migration of fluids and gases from the outside of the cable to the inner cable core.

Accordingly, a need exists for an electromechanical cable with improved fluid/gas migration protection. Additionally, a need exists for a faster and more consistent method for producing an electromechanical cable with fluid/gas migration prevention.

### SUMMARY OF THE INVENTION

One objective of the present invention is to provide an electromechanical cable suitable for use in subterranean environments, especially for down-well applications. Another object of the present invention is to provide an electromechanical cable that incudes fluid and/or gas migration protection.

The present invention generally relates to a gas and fluid blocked electromechanical cable comprising a cable core, a jacket layer, a sealing layer, and an armor layer. According to various embodiments, the sealing layer is configured as a gel or resin material with hardening properties. According to various embodiments, the sealing layer is configured as a thermoplastic elastomer, silicone-based material, or combination of both. Additionally, in certain embodiments of the present invention as described herein, the cable can include a plurality of jacket layers and armor layers depending on the desired use and operation of the cable. The arrangement and configuration of the jacket layers, armor layers, and sealing layer facilitate fluid and/or gas migration prevention.

According to one embodiment of the present invention, the cable core comprises any suitable electrical conductor or fiber optics configuration with or without an insulating layer extruded therearound. The jacket layer can be extruded around the cable core and can comprise any polymer, plastic or other suitable coating or jacketing materials.

In various embodiments, the sealing layer can be applied to the extruded cable core with the jacket layer already extruded therearound. The sealing layer can comprise a fluid-protecting gel- or resin-based material that is applied while in a liquid, semi-liquid, deformable, viscous, or gel-like consistency so that it can uniformly surround the extruded cable core and then fill and migrate through all the gaps and spaces between the armor wires of the armor layer. After which the sealing layer can harden or set into a structurally stable composition. In this embodiment, the gel or resin-like material of the sealing layer can have two distinguishable material states: a first material state where the sealing layer has a viscous or semi-viscous consistency; and a second material state where the sealing layer has a non-viscous and solid, non-deformable consistency. The sealing layer can be applied to the extruded cable core by passing through the cable core in a gel/resin/liquid bath of the sealing layer material in its deformable, first material state to form the sealing layer around the jacket layer, and subsequently set into its non-deformable, second material state by means of heat, pressure, or other method.

According to other various embodiments, the sealing layer can be extruded onto the core. The sealing layer can comprise a thermoplastic elastomer or a silicone-based material or may be a combination of both. This material, such as a silicone polymer, has a soft, deformable consistency. The material is a solid, but is deformable; it is not a liquid or a semi-viscous gel or resin. The material for the sealing layer according to this embodiment has only a single material state (as opposed to the material of the sealing layer in the embodiment described above) and may be applied to the core when the core is in its single and final state. Since the material is deformable, the armor wires are embedded into the sealing layer when the armor wires are wrapped around the core and sealing layer and the material of the sealing layer surrounds and fills in the gaps and spaces between the armor wires.

After the sealing layer is applied to the cable core, the armor layer can be wrapped around the sealing layer. The armor layer can comprise a plurality of armor wires wrapped around the sealing layer to form the armor layer having a specified lay direction. The armor wires can be compressed partially into the sealing layer creating a better bond between the jacket layer and the armor layer. For embodiments where the sealing layer comprises a gel- or resin-based compound material, the armor layer is wrapped around the sealing layer when the sealing layer is in a first material state where it has a viscous or semi-viscous consistency. Due to this material state, the armor wires are easily embedded into the sealing layer when wrapped around the cable. Additionally, due to the deformable state of the sealing layer, the sealing layer material can fill in and migrate through any remaining void spaces between the wires of the armor layer and the jacket layer. After wrapping the armor layer, the sealing layer can then be set into a hardened second material state to provide fluid and/or gas migration protection for the cable core. The application of the sealing layer in a viscous state prior to hardening can allow the armor wires to be fully embedded into and sealed and surrounded by the sealing layer. The viscous sealing layer can flow and migrate into all the small gaps, spaces and voids between the armor wires to fully engage the inward-faces surfaces of the armor wires. This can effectively seal the armor layer on its inward-facing surface and limit or prevent subsequent migration of fluids and gases during use of the cable.

For embodiments where the sealing layer comprises a thermoplastic elastomer or silicone-based material (or combination thereof), the armor layer is wrapped around the sealing layer and the armor wires are easily embedded into the sealing layer due to is solid but deformable material consistency. As the armor wires are wrapped around the sealing layer, the material of the sealing layer deforms to surround the portion of the armor wires facing the cable core and fill in gaps and spaces between adjacent armor wires and between the armor wires and cable core. The deformable characteristics of the sealing layer and embedding of the armor wires allow for the elimination and/or reduction of gaps and spaces between the armor layer and the cable core to restrict possible migration of fluids and/or gasses from outside the cable into the cable core. In this embodiment, the material comprising the sealing layer has only a single solid yet deformable material state, the cable can be formed without the additional step of applying heat and/or pressure to set the sealing layer, like that which is described above for the previous embodiment where the sealing layer comprises a gel- or resin-based material.

In certain embodiments, the cable described above can then have one or more additional jacket layers and armor wire layers extruded therearound. Each jacket layer and armor wire layer can be configured and incorporated into the cable in a manner similar to that described above. Each additional armor wire layer can have a specified lay direction, which can be opposite the lay direction if the prior armor wire layer to form a torque-balanced cable. Additionally, the additional armor wire layer or layers can be compressed into the preceding adjacent jacket layer in any suitable manner.

Other aspects and advantages of the present invention will be apparent from the following detailed description of the preferred embodiments and the accompanying drawing figures.

### DESCRIPTION OF THE SEVERAL VIEWS OF THE DRAWINGS

The accompanying drawings form a part of the specification and are to be read in conjunction therewith, in which like reference numerals are employed to indicate like or similar parts in the various views.

FIGS. 1A-1E are schematic sectional views of various cable cores for an electromechanical cable in accordance with one embodiment of the present invention;

FIGS. 2A-2E are schematic sectional views of a jacket layer surrounding the various cable cores for the electromechanical cable in accordance with one embodiment of the present invention;

FIG. 3 is a schematic sectional view of a sealing layer and an armor layer surrounding the jacket layer of the electromechanical cable in accordance with one embodiment of the present invention;

FIG. 4 is a schematic sectional view of a second jacket layer surrounding the first armor layer of the electromechanical cable in accordance with one embodiment of the present invention;

FIG. 5 is a schematic sectional view of a second armor layer and a third jacket layer surrounding the second jacket layer of the electromechanical cable in accordance with one embodiment of the present invention;

FIG. 6 is a schematic sectional view of an armor layer surrounding the sealing layer of the electromechanical cable in accordance with one embodiment of the present invention; and

FIG. 7 is a schematic sectional view of an armor layer surrounding the sealing layer of the electromechanical cable in accordance with one embodiment of the present invention.

### DETAILED DESCRIPTION OF THE INVENTION

The following detailed description of the invention references specific embodiments in which the invention can be practiced. The embodiments are intended to describe aspects of the invention in sufficient detail to enable those skilled in the art to practice the invention. Other embodiments can be utilized, and changes can be made without departing from the scope of the present invention. The present invention is defined by the appended claims and the description is, therefore, not to be taken in a limiting sense and shall not limit the scope of equivalents to which such claims are entitled.

The present invention is generally directed toward a gas and fluid blocked electromechanical cable or wireline cable 10 as illustrated throughout the figures. The electromechanical cable 10 can comprise a cable core 12, one or more jacket layers, one or more armor layers, and a sealing layer provided between the first jacket layer and the first armor layer as described in greater detail below. The sealing layer can comprise a specific type of material, which can be: (a) a gel or resin material that may be applied in a pliable, liquid, semi-liquid, viscous, and/or deformable state and then configured to harden and set into a non-viscous, non-deformable state; or (b) a solid, deformable material that may be applied and configured deforming around the armor wires of the armor layer to embed into the sealing layer. When the sealing layer is a pliable, liquid, semi-liquid, viscous, and/or deformable state, the sealing layer can also comprise a gel- or resin-type material that has a slightly formed and semi-viscous (viscosity substantially less than that of water or similar liquid) consistency, where the sealing layer material is applied in this state and remains in this state after application (i.e., the sealing layer material does not necessarily harden into a fully set, non-viscous state). When the sealing layer is solid and deformable, the sealing layer can comprise thermoplastic elastomer or silicone-based material or a combination of both, and the armor wires may embed into the sealing layer; no heating or other manufacturing step to “set” the sealing layer is required and the sealing layer may remain in a solid yet deformable material state. The sealing layer can enable the space between the first jacket layer and the armor layer to be uniformly filled with minimal or no gaps or void spaces in order to limit and prevent fluid migration into the cable core 12.

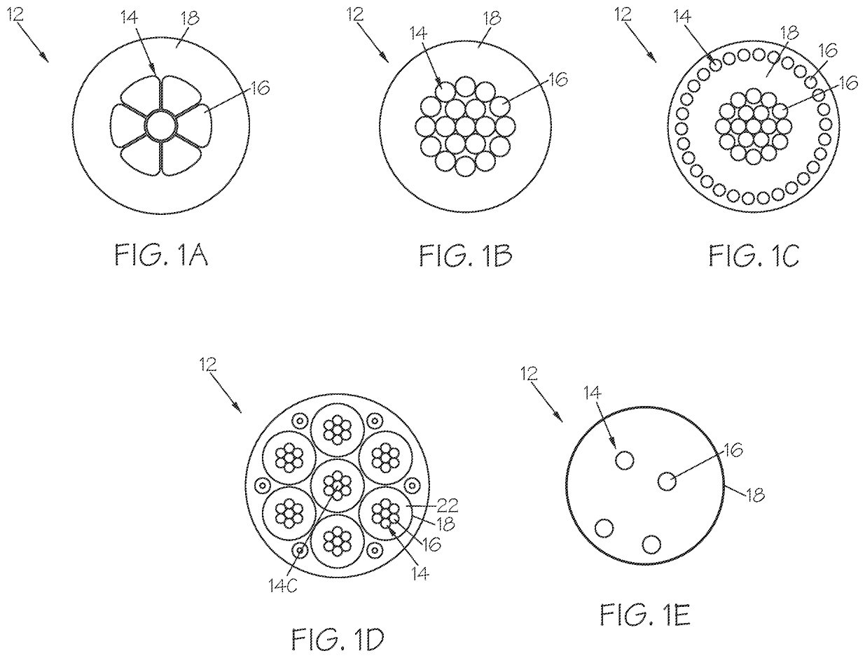

As shown in FIGS. 1A-1E, the cable core 12 can include a conductor 14 having at least one conductor wire 16 with conductive properties, such as copper wires or other suitable conductive material. The conductor 14 may alternatively or additionally be configured as a fiber optics having at least one fiber optics element 16 in certain embodiments and configurations of the invention. Conductor 14 may be any type of electrical conductor configuration or fiber optics configuration suitable for signal transmission, power transmission, or any other form of electronic or data transmission. According to one embodiment of the present invention, conductor 14 can include a single conductor wire 16. According to another embodiment, conductor 14 can include a plurality of conductor wires 16, as demonstrated in FIGS. 1A-1C. In other alternative embodiments, cable core 12 can comprise one or more separately jacketed conductors, compacted conductor wires or other configurations, such as in FIG. 1D. The conductor 14 may also be a fiber in metallic tube (“FMIT”), as shown in FIG. 1E. For purposes of the following description, conductor 14 may mean a traditional conductor, such as copper or other conductive material, a fiber optics, or any combination thereof. The diameter of conductor 14 can vary depending on the desired application and power capacity of electromechanical cable 10.

The cable core 12 can include an insulating layer 18 formed around the conductor 14. The insulating layer 18 may be extruded around conductor 14. Insulating layer 18 can comprise any jacketing or coating material or combination of materials commonly used in commercial wire or wire rope, including but not limited to ethylene tetrafluoroethylene (“ETFE”), polytetrafluoroethylene (“PTFE”), ePTFE tape produced by Gore®, perfluoroalkoxyalkane (“PFA”), fluorinated ethylene propylene (“FEP”), or any insulating material now known or hereafter developed. The thickness of insulating layer 18 can vary depending on the desired application of electromechanical cable 10.

As shown in FIG. 1A, cable core 12 can comprise a single conductor 14 with a plurality of conductor wires 16 where conductor 14 is compacted prior to application of insulating layer 18. Conductor 14 can be compacted to smooth or flatten the outer surface of the plurality of conductor wires 16. As shown in FIG. 1A, the compaction step significantly deforms the cross-section of the originally round conductor wires 16 into a generally “D” or triangular shape. Compaction reduces the voids between each conductor wire 16, thereby creating a denser distribution of conductor wires 16 in conductor 14. After conductor wires 16 are compacted, first jacket layer 20 can be applied to encapsulate conductor wires 16 by co-extruding first jacket layer 20 over conductor wires 16.

As shown in FIG. 1D, cable core 12 can comprise a plurality of conductors 14. Each conductor 14 comprises a plurality of conductor wires 16 surrounded by an insulator jacket 22. Insulator jacket 22 can be constructed from a number of different materials similar to insulating layer 18 described above. Each conductor 14 can also be compacted in a manner similar to that described above. A plurality of conductors 14 can be oriented within cable core 12. In such an embodiment, as shown in FIG. 1D, six (6) conductors 14 are helically wrapped around center conductor 14c. However, a person of skill in the art will appreciate that any common numbers of the plurality conductors 14 may be used. Cable core 12 may often include a number of conductors in a range from 1-10 depending upon the down-hole requirements and overall diameter of the cable needed. However, any number of conductors is within the scope of the present invention.

Insulating layer 18 surrounds conductor 14 to form cable core 12. Insulating layer 18 can be applied to conductor 14 by extrusion or any other jacketing method commonly used in the art. Such methods can include, but are not limited to, taping, volcanizing, ram extrusion and the like. The overall diameter of cable core 12 depends on the diameter of conductor 14 and the thickness of insulating layer 18 and it is recognized that cable core 12 can have any diameter depending on the particular use and application of cable 10.

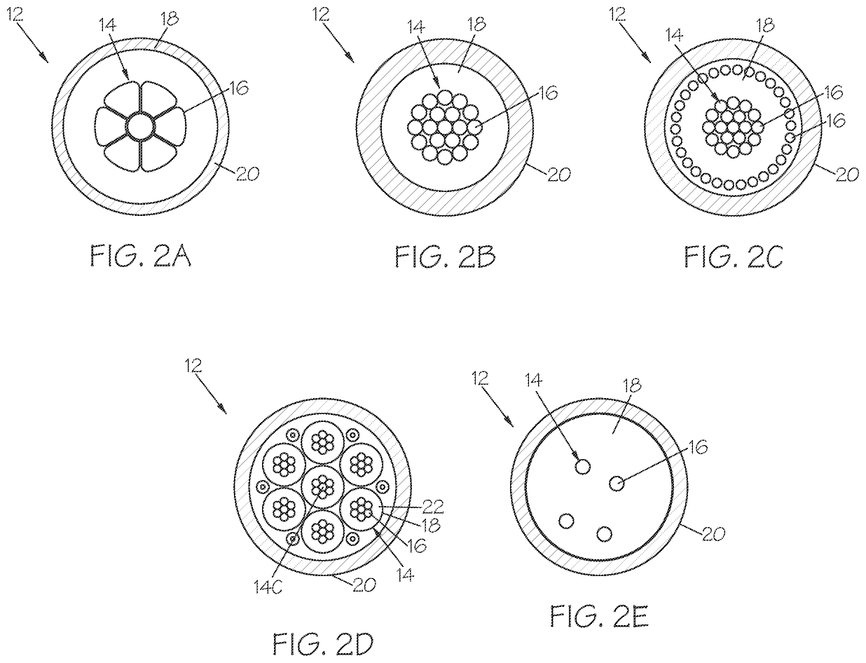

As shown in FIGS. 2A-2E, cable core 12 can be surrounded by a first jacket layer 20. Similar to insulating layer 18, first jacket layer 20 can comprise any jacketing or coating material. The first jacket layer 20 may be made from one or more of ethylene-tetrafluoroethylene (“ETFE”), polytetrafluoroethylene (“PTFE”), polyether ether ketone (“PEEK”), ePTFE tape produced by Gore®, perfluoroalkoxyalkane (“PFA”), fluorinated ethylene propylene (“FEP”), polyvinylidene fluoride (“PVDF”), carbon fiber-ETFE (“CFE”), perfluoromethoxy polymers, or any mixture thereof. Alternative materials not identified above may also be used for first jacket layer 20. First jacket layer 20 may contain fillers to improve abrasion resistance behavior or electrostatic dissipation reduction. Non-limiting examples of possible fillers include carbon fibers, carbon black, Kevlar fiber, and Kevlar powder.

First jacket layer 20 can be applied to cable core 12 through extrusion or any other jacketing method known in the art. The thickness of first jacket layer 20 can vary depending on the desired use and application of electromechanical cable 10 and the range of sizes, thicknesses, and diameters for first jacket layer 20 (or any other of the layers described herein) can easily be scaled up or down to result in an electromechanical cable of varying layer thickness and overall sizes as desired or required for certain applications.

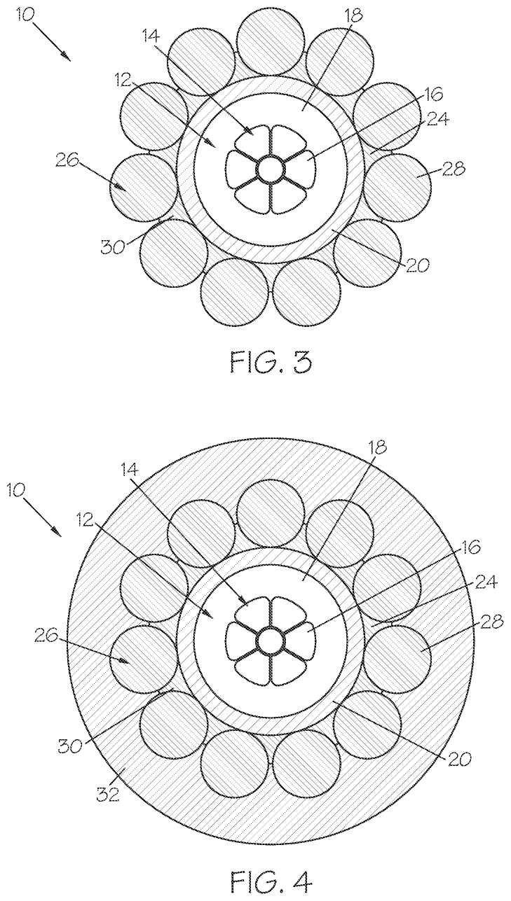

As shown in FIG. 3, electromechanical cable 10 can include a sealing layer 24 surrounding first jacket layer 20 and disposed therearound. Sealing layer 24 can be configured as a fluid and/or gas protecting material layer applied to the extruded cable core, which includes cable core 12 with first jacket layer 20. According to certain embodiments, sealing layer 24 can comprise a resin material, gel material, two-part epoxy material, synthetic filler material or other type of suitable fluid-protecting material that may have a soft, deformable, viscous, semi-viscous, and/or gel-like consistency. According to this embodiment, the material of sealing layer 24 does not hold a constant shape and deforms based on the surrounding structure due to the at least semi-viscous consistency of the material. According to certain embodiments, the material used for sealing layer 24 may have a liquid, semi-liquid, deformable, or viscous consistency, or have high viscosity in at least one material state.

According to certain embodiments, the material used for sealing layer 24 has at least a first material state where the material is viscous or deformable, and at least a second material state where the material has hardened or set into a non-viscous, rigid, or semi-rigid configuration. The hardening or setting may be a result of heating, cooling, pressure or other application. Additionally, in alternative embodiments, sealing layer 24 can comprise a gel- or resin-type material with a viscous or semi-viscous consistency (i.e., viscosity less than that of water), where the material of the sealing layer 24 remains at this consistency before and after application as sealing layer 24. In such embodiments, sealing layer 24 need not necessarily be configured from a material having a first deformable material state and a second non-deformable material state.

According to one embodiment, sealing layer 24 can comprise Sepigel™ H200 (or similar compound material), which is a hydrogen scavenging gel compound having high viscosity and strong mechanical properties. Sepigel H200 is also a type of resin that is soft at room temperature and hardens upon stress or pressure. According to another embodiment, sealing layer 24 can comprise an Oppanol™ type epoxy compound (or similar compound material). Oppanol is a polysobutene/polyisobutene flexible barrier adhesive or sealant that contains high viscosity. Oppanol typically has a firm, hardened material state at room temperature, softens into a gel-like consistence upon heating, and then hardens and sets upon cooling. Both Sepigel and Oppanol have an at least semi-viscous material state in which the material is deformable and then may be hardened or set into a rigid, non-deformable shape upon the application of heat or pressure. When sealing layer 24 comprises Sepigel, Oppanol, or a similar type compound material, sealing layer 24 may be applied to cable core 12 (and jacket layer 20) in a first material state with a deformable, viscous consistency, and then sealing layer 24 can be transitioned to a second material state that is a solid, non-viscous (or at least a viscosity less than that of first material state) consistency. It is also recognized that any other suitable material now known or hereinafter developed may also be used for sealing layer 24.

Sealing layer 24 can be applied to extruded cable core 12 (cable core 12 with first jacket layer 20 extruded around) by running cable core 12 through a bath containing the resin/gel-type material of sealing layer 24, applying the resin/gel-type material directly onto cable core 12, extruding the resin/gel-type material onto cable core 12, or any other suitable method. In particular, the material of sealing layer 24 is in a semi-liquid, viscous or deformable material state as described above upon application to extruded cable core 12 and first jacket layer 20 so that a thickness of the resin material uniformly and fully surrounds first jacket layer 20 upon initial application.

According to other various embodiments, sealing layer 24 can be configured as a deformable solid protecting material layer extruded onto cable core 12 (with optionally a first jacket layer 20 extruded therearound). According to this embodiment, the material for sealing layer 24 is a solid material that maintains its shape but easily deforms upon the application of contact or force onto the surface of the material. According to this embodiment, sealing layer 24 can comprise a thermoplastic elastomer or a silicone-based material or a combination of both. According to certain embodiments, the material used for sealing layer 24 may be any suitable material having solid yet deformable consistency.

According to one embodiment, sealing layer 24 can comprise Teknor Apex® Medalist® MD-12337, which is a thermoplastic elastomer. Medalist® MD-12337 is a low hardness, low density material that is suitable for extrusion. According to another embodiment, sealing layer 24 can comprise DuPont™ TPSiV® 400-50A, which is a thermoplastic elastomer. TPSiV® 400-50A is a thermoplastic elastomer, with associated characteristics of strength, toughness, and abrasion resistance, that is combined with silicone, with associated characteristics of softness, silky feel, and resistance to UV light and chemicals. Both Medalist® MD-12337 and TPSiV® 400-50A have a solid material state in which the material is deformable. Any other suitable material that has a solid, deformable consistency now known or hereinafter developed may also be used for sealing layer 24. Sealing layer 24 can be extruded onto the cable 10 (cable core 12 with first jacket layer 20 extruded around) by applying the layer directly onto cable core 12, extruding the layer onto cable core 12, or any other suitable method.

As further shown in FIG. 3, electromechanical cable 10 can include a first armor layer 26 surrounding sealing layer 24 and disposed therearound. First armor layer 26 can comprise a plurality of armor wires 28 helically wrapped around first jacket layer 20 and cable core 12. Armor wires 28 comprising first armor layer 26 can have various shapes and configurations depending on the particular application of electromechanical cable 10. Armor wires 28 can comprise any wire material or type commonly used in art, such as steel wires, which can be extra high strength (“EHS”), high-strength steel wires, galvanized steel, stainless steel, or carbon. The diameter or thickness of each armor wire 28, and correspondingly the thickness of first armor layer 26, can vary depending on the specific application of electromechanical cable 10. The plurality of armor wires 28 can be wound with either a left or a right lay of varying angles. Prior to applying additional layers around first armor layer 26, first armor layer 26 can be cleaned using a plasma cleaning method to improve adhesion of the polymer to armor wires 28.

First armor layer 26 can be wrapped around the sealing layer 24 in various lay configurations depending on the particular embodiment as described in greater detail below. First armor layer 26 may also be applied to the extruded cable core 12 (with first jacket layer 20 and sealing layer 24) as the material comprising sealing layer 24 is in its semi-liquid, viscous or deformable state. According to embodiments where the sealing layer 24 comprises a gel- or resin-type material, as the armor wires 28 are wrapped around sealing layer 24, the armor wires 28 depress into the gel/resin material of sealing layer 24 and the gel/resin material flows around and into any void spaces, gaps or openings created between the armor wires 28 and first jacket layer 20. Additionally, or optionally, once wrapped around sealing layer 24, first armor layer 26 can be compressed into sealing layer 24 such that armor wires 28 create indentations in sealing layer 24 and nest therein, as best shown in FIGS. 3-4.

Similarly, according to embodiments where the sealing layer 24 is a thermoplastic elastomer, silicone-base material or other solid deformable material, as the armor wires 28 are wrapped around sealing layer 24, the armor wires 28 depress into the solid deformable material, the solid deformable material deforms to fill in gaps and spaces between adjacent armor wires 28 and between armor wires 28 and cable core 12, and the armor wires 28 are indented into sealing layer 24.

Because the material of sealing layer 24 is soft and deformable when first armor layer 26 is applied thereon, armor wires 28 can nest into sealing layer 24 so that a plurality of spaces or voids 30 between adjacent armor wires 28 and first jacket layer 20 are substantially filled. According to embodiments where sealing layer 24 comprises a gel- or resin-type material, after first armor layer 26 is applied to sealing layer 24, the gel/resin material comprising sealing layer 24 can be configured to set and/or harden to a second material state of the sealing layer 24. In the second material state, the sealing layer 24 is substantially rigid and non-deformable. For example, for a Sepigel-based resin material, pressure can be applied to harden the sealing layer 24, while for an Oppanol-based resin material, the resin material may be cooled to harden the sealing layer 24. As best shown in FIG. 3, prior to hardening, the gel/resin material of sealing layer 24 migrates and flows into all of the voids 30 between armor wires 28 and first jacket layer 20 so that the space therebetween is uniformly filled with the resin material. Upon hardening, the sealing layer 24 forms a structurally stable fluid-blocking layer around the extruded cable core 12. Alternatively, the sealing layer 24 may be left in its first material state (i.e., a semi-viscous material state) in certain embodiments.

As shown in FIG. 4, according to certain embodiments of the invention, a second jacket layer 32 can be disposed around first armor layer 26. Second jacket layer 32 can be constructed in a similar manner as first jacket layer 20 and can also be comprised of any jacketing or coating material. According to certain embodiments, second jacket layer 32 can comprise Tefzel or Carbon Fiber ETFE; however, any other suitable polymer material or other material can be used. Second jacket layer 32 can be extruded onto first armor layer 26 (or otherwise applied to first armor layer 26) using any suitable method. According to one embodiment, second jacket layer 32 can be compressed or pressed onto and into armor wires 28 of first armor layer 26 to fill in spaces between adjacent armor wires 28. Second jacket layer 32 can fill a plurality of spaces or voids 34 between the plurality of armor wires 28 on an outer surface of first armor layer 26. This can be accomplished during extrusion of second jacket layer 32 and/or by compressing second jacket layer 32 onto the plurality of armor wires 28 of first armor layer 26. This can result in the perimeter of the plurality of armor wires 28 being completely or substantially surrounded by first jacket layer 20 and second jacket layer 32 as shown in FIG. 4.

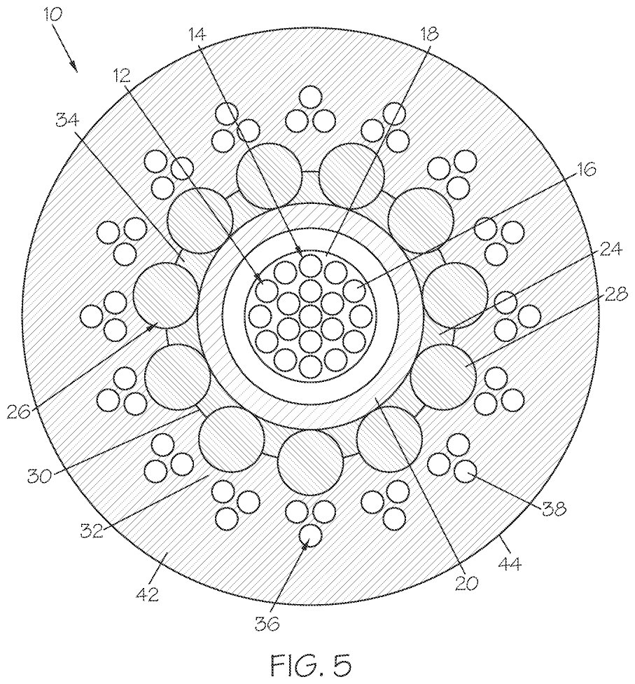

As shown in FIG. 5, a second armor layer 36 can be helically wrapped around and surround second jacket layer 32. Second armor layer 36 can be laid in various configurations similar to first armor layer 26. Second armor layer 36 can be wound in a right lay or left lay depending on the particular embodiment of the present invention. In one embodiment, second armor layer 36 is wound with a lay that is opposite of first armor layer 26. The opposing lay directions between first and second armor layers 26 and 36, respectively, can provide greater torque balance in electromechanical cable 10.

Second armor layer 36 can be constructed from different types of wires or wire strands 38, including symmetric 3-wire strands as shown in FIG. 5, a-symmetric 3-wire strands (not shown), single wires (not shown), or any combination thereof. In some embodiments, the 3-wire strands can be compacted to change the perimeter shape and cross-section of the strands. Compaction can provide a “rounder” exterior shape of the strands. Wires 38 can have a spaced configuration so there is a void or gap 40 between each of wires 38, as shown in FIG. 5. According to one embodiment, wires 38 can be configured as symmetric 3-wire strands 38 that can be twisted or otherwise formed as known in the art. The wires of 3-wire strands 38 can comprise any wire or strand material or type known in the industry. Second armor layer 36 may also be comprised of a plurality of single wires 38 similar to first armor layer 26. The wire or strand material can include steel wires, which can be extra high strength (“EHS”), high-strength steel wires, galvanized steel, or stainless steel. Aluminum and synthetic wire as known in the art can also be used. In some embodiments, the wires used within each armor layer can be metallic, synthetic fiber, or combination thereof.

Second armor layer 36 can be compressed into second jacket layer 32 when wrapped around second jacket layer 32 or after wrapping. According to one embodiment, heat can be applied cable 10 as second armor layer 36 is being formed onto the extruded cable (comprising cable core 12, first jacket layer 20, sealing layer 24, first armor layer 26, and second jacket layer 32). According to one embodiment, extruded cable core 12 can be passed through a closing die to embed second armor layer 36 into second jacket layer 32. Heat can be applied by any suitable heat method applications during this process. In one embodiment, extruded cable core 12 is heated, and as cable 10 passes through the closing die, second armor layer 36 gets embedded into extruded cable core 12. In another embodiment, the closing die is heated, and as cable 10 passes through the closing die, second armor layer 36 gets embedded into extruded cable core 12. In yet another embodiment, cable 10 passes through the closing die, and heat is applied to cable 10 as cable 10 exits the closing die, embedding second armor layer 36 into extruded cable core 12. Second armor layer 36 can also be plasma cleaned to improve plastic adhesion.

In certain embodiments of the present invention, cable 10 can also include a third jacket layer 42. Third jacket layer 42 can surround second armor layer 36, as shown in FIG. 5. Similar to the previously discussed polymer jacket layers, third jacket layer 42 can be comprised of any jacketing or coating material and can be applied through extrusion or any other jacketing method known in the art. Third jacket layer 42 can penetrate into one or more gaps 40 between wire strands 38 so as to substantially surround wire strands 38. Third jacket layer 42 can also include a smooth outer surface 44. Accordingly, in one embodiment, the thickness of third jacket layer 42 can cover the entirety of second armor layer 36.

In certain alternative embodiments of the present invention, cable 10 can include a second sealing layer disposed between second jacket layer 32 and second armor layer 36. In such embodiments, second sealing layer is applied around second jacket layer 32 (with cable core 12, first jacket layer 20, sealing layer 24, and first armor layer 26) in the same manner as described above with respect to sealing layer 24. The material of second sealing layer may also be configured as either a resin or gel-type material that is in a semi-viscous or viscous deformable state, or can be a solid deformable material such as a thermoplastic elastomer or silicone-based material. After second sealing layer is applied around second jacket layer 32, second armor layer 36 can be wrapped around second sealing layer and embedded therein due to the deformable consistency of the material comprising the second sealing layer. In embodiments where the second sealing layer comprises a resin- or gel-type material, the second sealing layer can then be set into a substantially rigid, and non-deformable state as described above with respect to sealing layer 24.

In other certain embodiments, second jacket layer 32 may comprise a second sealing layer. In such embodiment, second jacket layer 32 is replaced with a second sealing layer 32 that is identical to sealing layer 24. After first armor layer 26 is wrapped around sealing layer 24, second sealing layer 32 may be applied around first armor layer 26 (extrusion or other means). The material of second sealing layer 32 may comprise a gel- or resin-type material or a solid deformable material identical to the materials described above with respect to sealing layer 24. Because of the semi-viscous or deformable consistency of the material comprising second sealing layer 32, the material deforms around the outward facing portions of the armor wires 28 of first armor layer 26. Second armor layer 36 may then be wrapped around second sealing layer 32 and embedded therein due to semi-viscous or deformable consistency of second sealing layer 32. The material of second sealing layer moves into and fills the spaces and gaps between adjacent armor wires 28 of first armor layer 36, between adjacent armor wires 38 of second armor layer 26, and between first and second armor layers 26 and 36.

The cable 10 described herein can be formed and constructed using any suitable process or method. According to certain embodiments, the method and process of forming electromechanical cable 10 may be performed in a continuous forming line. According to one embodiment, particularly where sealing layer 24 comprises a resin or gel-like material as described above (such as Sepigel, Oppanol or similar material compound) that has a first material state of a viscous or semi-viscous consistency, the method of forming the cable 10 can include providing a cable core 12 and extruding a first jacket layer 20 around the cable core 12. The extruded cable core 12 may then be passed through a sealing bath containing the resin or gel-like compound material of sealing layer 24 so that a thickness of compound material is applied onto first jacket layer 20. Then first armor layer 26 may be wrapped around the extruded cable core 12 with the compound material of sealing layer 24. After wrapping first armor layer 26, the resin material of the sealing layer 24 can be set and/or hardened so that sealing layer 24 is in a structurally stable and rigid material state. The second jacket layer 32 may then be extruded onto first armor layer 26. A second armor layer 36 may then optionally be wrapped around second jacket layer 32 followed by a third jacket layer 42 that may be optionally extruded onto second armor layer 36.

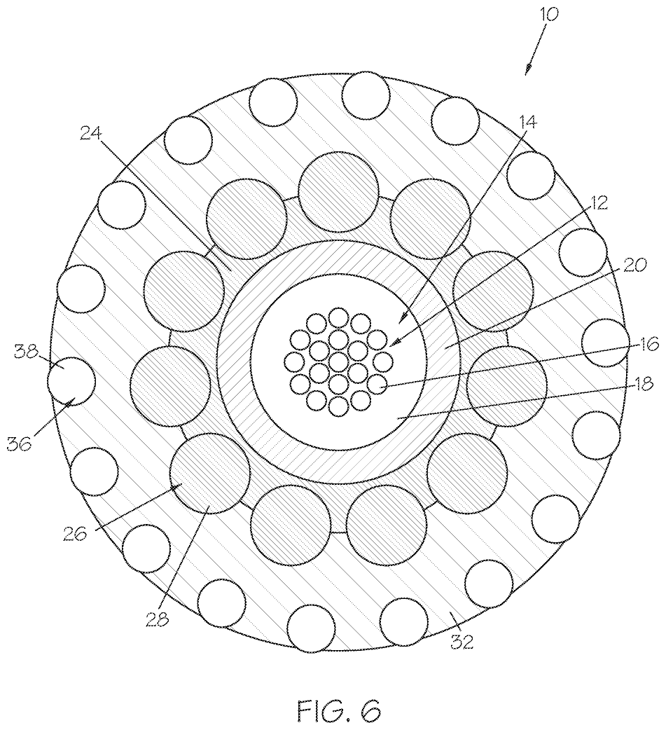

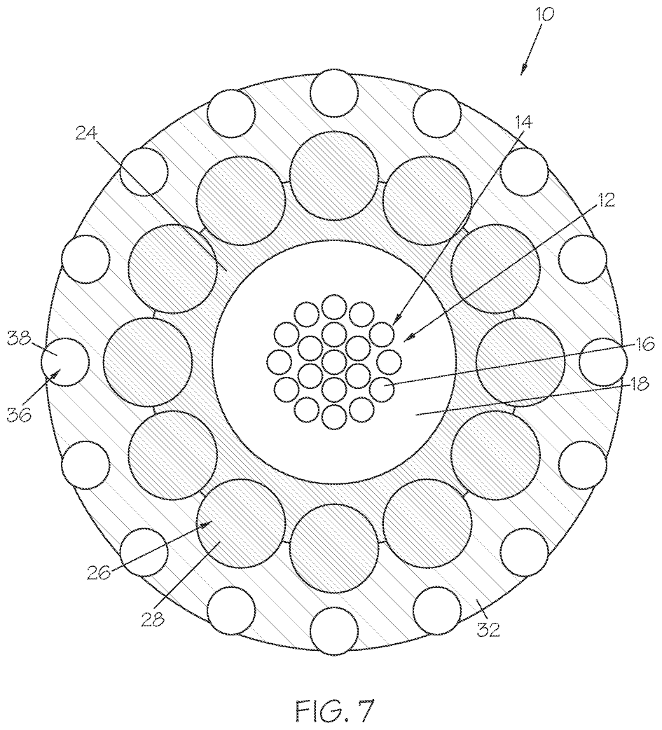

In other embodiments, as illustrated in FIGS. 6 and 7, the cable 10 may not include a third jacket layer 42 so that the second armor layer 36 is the outermost layer on the cable 10. When the armor layer, rather than a jacket layer, is the outermost layer on the cable 10, the cable 10 is referred to as an unjacketed cable. As shown in FIG. 6, when the second armor layer 36 is the outermost layer of cable 10, the wires 28 of second armor layer 36 can be compressed into second jacket layer 32 as described above so that second armor layer 36 is substantially embedded into second jacket layer 32.

According to another embodiment, particularly where sealing layer 24 comprises a thermoplastic elastomer or silicone-based material that has only a single material state of a solid yet deformable consistency, a method of forming cable 10 can include providing a cable core 12 and optionally extruding a first jacket layer 20 around the cable core 12. The sealing layer 24 may then be extruded around the combined cable core 12 and first jacket layer 20 so that a thickness of the sealing layer 24 surrounds the first jacket layer 20. First armor layer 26 may then be wrapped around the combined cable core 12, first jacket layer 20, and sealing layer 24. As a result of the deformable material characteristics of the material comprising sealing layer 24, the wires 28 of the first armor layer 26 may easily be at least partially compressed into and embedded into sealing layer 24. The second jacket layer 32 may then be extruded onto first armor layer 26 to form cable 10. In certain embodiments, a second armor layer 36 may additionally be wrapped around second jacket layer 32 to form an unjacketed cable 10. In yet other certain embodiments, a third jacket layer 42 may be extruded onto second armor layer 36 to form a jacketed cable 10.

According to other embodiments, the method may alternatively include providing a second sealing layer around second jacket layer 32 prior to wrapping second armor layer 36. According to yet other embodiments, the method may alternatively include extruding a second sealing layer 32 around first armor layer 26 and omitting second jacket layer 32.

Because the material of sealing layer 24 is deformable, when first armor layer 26 and second armor layer 36 are applied thereon, armor wires 28, 38 can nest into sealing layer 24. Because sealing layer 24 is solid, the sealing layer 24 does not need to be hardened or set. The sealing layer 24 forms a structurally stable fluid-blocking layer around the extruded cable core 12.

As shown in FIG. 7, electromechanical cable 10 can include a sealing layer 24 surrounding cable core 12, when such cable core 12 is not surrounded by a jacket layer. Sealing layer 24 can be configured as a deformable solid protecting material layer extruded onto the cable 10. First armor layer 26, second armor layer 36, and sealing layer 24 may be applied to the cable core 12 in the manner as discussed in greater detail with reference to FIGS. 3-6 above.

From the foregoing, it will be seen that this invention is one well adapted to attain all the ends and objects hereinabove set forth together with other advantages which are obvious, and which are inherent to the structure. It will be understood that certain features and sub combinations are of utility and can be employed without reference to other features and sub combinations. This is contemplated by and is within the scope of the claims. Since many possible embodiments of the invention can be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including”, and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

We claim:

1. An electromechanical cable comprising:
a cable core comprising at least one of a conductor and a fiber optic;
a first jacket layer surrounding the cable core;
a sealing layer surrounding the first jacket layer; and
a first armor layer surrounding the sealing layer, the first armor layer comprising a plurality of armor wires;
wherein the plurality of armor wires of the first armor layer is embedded into the sealing layer.

2. The electromechanical cable of claim 1, wherein the sealing layer comprises a deformable material and the plurality of armor wires extends at least partially into and are embedded in the deformable material.

3. The electromechanical cable of claim 1, wherein the sealing layer comprises one or more of a resin material, a gel material, a two-part epoxy material, and a synthetic filler material.

4. The electromechanical cable of claim 3, wherein the sealing layer is applied to the first jacket layer in a viscous or semi-viscous material state.

5. The electromechanical cable of claim 1, wherein the sealing layer comprises a deformable solid material, and wherein the sealing layer is configured for the plurality of armor wires to sink into the sealing layer.

6. The electromechanical cable of claim 5, wherein the deformable solid material comprises a thermoplastic elastomer material, a silicone-based material, or a combination of a thermoplastic elastomer material and a silicone-based material.

7. The electromechanical cable of claim 1, wherein the sealing layer extends substantially into a region between the first jacket layer and the first armor layer so that no void spaces or gaps of air exist between the first jacket layer and the first armor layer.

8. The electromechanical cable of claim 1, wherein the plurality of armor wires is wrapped around the sealing layer to form the first armor layer, and wherein the sealing layer is hardened after the first armor layer is formed onto the sealing layer.

9. The electromechanical cable of claim 1, further comprising:
a second jacket layer surrounding the first armor layer, the second jacket layer substantially surrounding the plurality of armor wires of the first armor layer; and
a second armor layer surrounding the second jacket layer, the second armor layer comprising a plurality of armor wires wrapped around the second jacket layer and compressed to indent the second jacket layer.

10. A method for manufacturing an electromechanical cable comprising the steps of:
providing a cable core;
applying a sealing layer onto an outer surface of the cable core, wherein the sealing layer comprises a deformable material; and
wrapping a first armor layer around the sealing layer, the first armor layer comprising a plurality of armor wires, wherein the plurality of armor wires embeds into the deformable material of the sealing layer so that no void spaces or air gaps remain between the cable core and the first armor layer.

11. The method of claim 10, wherein the cable core comprises at least one of a conductor and a fiber optic.

12. The method of claim 10, wherein the deformable material of the sealing layer comprises at least one of a resin material, a gel material, a two-part epoxy, and a synthetic filler material, and wherein the sealing layer is applied onto the cable core in a first material state where the deformable material of the sealing layer is viscous or semi-viscous, and wherein the deformable material of the sealing layer is configured to transition to a second material state where the sealing layer has a substantially rigid shape.

13. The method of claim 12, further comprising the step of setting the sealing layer, wherein the step of setting the sealing layer comprises transitioning the deformable material from the first material state to the second material state after the first armor layer is wrapped around the sealing layer.

14. The method of claim 13, wherein the step of setting the sealing layer comprises one of:
applying a compressive of pressure force to the electromechanical cable;
cooling the resin material of the sealing layer; or
heating the resin material of the sealing layer.

15. The method of claim 10, wherein the sealing layer comprises a deformable solid material, and wherein the sealing layer is configured for the plurality of armor wires to sink into the sealing layer.

16. The method of claim 15, wherein the deformable solid material of the sealing layer comprises at least one of a thermoplastic elastomer material and a silicone-based material.

17. The method of claim 10, further comprising the steps of:
extruding a first jacket layer over the cable core;
extruding a second jacket layer over the first armor layer; and
wrapping a second armor layer around the second jacket layer.

18. An electromechanical cable comprising:
a cable core comprising at least one of a conductor and a fiber optic and an insulating layer;
a first jacket layer surrounding the cable core;
a sealing layer surrounding the first jacket layer and the cable core;
a first armor layer surrounding the sealing layer, the first armor layer comprising a plurality of armor wires, wherein the plurality of armor wires extends at least partially into the sealing layer;
a second jacket layer surrounding the first armor layer; and
a second armor layer surrounding the second jacket layer, the second armor layer comprising a plurality of armor wires.

19. The electromechanical cable of claim 18, wherein the sealing layer comprises at least one of a thermoplastic elastomer material at a silicone-based material.

20. The electromechanical cable of claim 18, wherein the sealing layer comprises at least one of:
a resin material;
a gel-based material;
a two-part epoxy; and
a synthetic filler material.
